(19) United States
(12) Patent Application Publication
(10) Pub. No.: US 2012/0301767 A1
(43) Pub. Date: Nov. 29, 2012

(54) REDOX FLOW BATTERY

(76) Inventor: Hee-Tak Kim, Yongin-si (KR)

(21) Appl. No.: 13/416,942

(22) Filed: Mar. 9, 2012

(30) Foreign Application Priority Data
May 24, 2011 (KR) 10-2011-0049053

(51) Int. Cl. H01M 4/36; H01M 4/62; B82Y 30/00

(52) U.S. Cl. 429/105; 429/101; 977/742

(57) ABSTRACT

A redox flow battery, which includes an electrode assembly including a separator with positive and negative electrodes positioned respectively at both sides of the separator; a positive electrode supplier supplying a positive active material liquid to the positive electrode; and a negative electrode supplier supplying a negative active material liquid to the negative electrode. At least one of the positive and negative electrodes includes an electron-conductive substrate and a fine carbon layer on the electron-conductive substrate. This fine carbon layer includes carbon black, carbon nanotube, or a mixture of carbon black and carbon nanotube.

### CROSS-REFERENCE TO RELATED APPLICATION

This application claims priority to and the benefit of Korean Patent Application No. 10-2011-0049053, filed in the Korean Intellectual Property Office on May 24, 2011, the entire content of which is incorporated herein by reference.

### BACKGROUND

1. Field

This disclosure relates to a redox flow battery.

2. Description of Related Art

A rechargeable battery is utilized to transform electrical energy into chemical energy and to store this chemical energy, and then to retransform the chemical energy back into electrical energy. Here, a rechargeable battery having a lighter weight has been actively researched.

Recently, a redox flow battery has garnered attention as a high-capacity and high efficiency rechargeable battery, which may be appropriate or suitable for a large system such as an electric power storage system and the like.

The redox flow battery includes active material in aqueous solution-type ions rather than in a solid-state as in a typical battery and stores/generates energy through oxidation/reduction reaction of the aqueous solution-type ions at the positive and negative electrodes.

### SUMMARY

An aspect of an embodiment of the present invention is directed toward a redox flow battery having improved voltage efficiency.

An embodiment of the present invention provides a redox flow battery including an electrode assembly including a separator with positive and negative electrodes positioned on both sides of the separator; a positive electrode supplier including a positive active material liquid supplied to the positive electrode; and a negative electrode supplier including a negative active material liquid supplied to the negative electrode. Herein, at least either one of the positive and negative electrodes may include an electron-conductive substrate and a fine carbon layer on the electron-conductive substrate.

The fine carbon layer may include carbon black, carbon nanotube, or a mixture of carbon black and carbon nanotube. In other embodiment, the fine carbon layer may be the mixture of carbon black and carbon nanotube.

The fine carbon layer may have a thickness ranging from 5 μm to 100 μm and in another embodiment, 10 μm to 50 μm.

When the fine carbon layer is made of the mixture of carbon black and carbon nanotube, the carbon black and the carbon nanotube may be mixed in a ratio ranging from 90:10 wt % to 50:50 wt %.

The electron-conductive substrate may be made of carbon paper, carbon cloth, carbon felt, or a combination thereof.

The separator may include a cation conductive polymer having a sulfonic acid group, a carboxylic acid group, a phosphoric acid group, a phosphonic acid group, or a cation exchange group of a derivative thereof at the side chain or a porous polymer of porous polyethylene, porous polypropylene, porous polyvinylchloride, or a combination thereof.

The positive active material may include a 5-valent to tetravalent vanadium-based compound and for example, (VO₂)₂SO₄, VO(SO₄), or a combination thereof.

The positive active material liquid may include a mixture of sulfuric acid and water as a solvent.

The positive active material liquid may have a concentration ranging from 1 M to 10 M.

The negative active material may be a divalent to tetravalent vanadium-based compound and include, for example, VSO₄, V₂(SO₄)₃ or a combination thereof.

The negative active material liquid may include a mixture of sulfuric acid and water as a solvent.

The negative active material liquid may have a concentration ranging from 1 M to 10 M.

Hereinafter, further embodiments will be described in detail.

An embodiment of the present invention provides a redox flow battery with excellent efficiency.

### BRIEF DESCRIPTION OF THE DRAWINGS

FIG. 1 provides a drawing schematically showing the structure of an electrode of a redox flow battery according to an embodiment of the present invention.

FIG. 2 provides a drawing schematically showing the structure of a redox flow battery according to an embodiment of the present invention.

FIG. 3 provides SEM photographs of the surface of an electrode according to Examples 1 to 5.

FIG. 4 provides an SEM photograph of the surface of an electrode according to Comparative Example 1.

### DETAILED DESCRIPTION

Exemplary embodiments of the present disclosure will hereinafter be described in more detail. However, these embodiments are only exemplary, and this disclosure is not limited thereto.

One embodiment of the present invention provides a redox flow battery. In general, a redox flow battery may include aqueous solution-type positive and negative active materials. When the positive and negative active material solutions are supplied to an electrode assembly including positive and negative electrodes and a separator, each ion may have an oxidation/reduction reaction at the positive and negative electrodes, thereby generating electrical energy.

In other words, when a tetravalent vanadium ion (e.g., a +4 oxidation state vanadium ion) is oxidized into a pentavalent vanadium ion (e.g., a +5 oxidation state vanadium ion) at the positive electrode during the charge reaction, a proton moves through a separator from the positive electrode to the negative electrode, while an electron is consumed. On the other hand, a trivalent vanadium ion (e.g., a +3 oxidation state vanadium ion) receives the electron and is reduced into a divalent vanadium ion (e.g., a +2 oxidation state vanadium ion) at the negative electrode. On the contrary, an oxidation/reduction reaction, that is, a redox reaction, occurs during the discharge reaction, that is to say, a vanadium ion has a different oxidation state (oxidation number).

The separator should pass protons through, but block cations of the positive and negative active materials from moving toward the counter electrode.

In addition, the positive and negative electrodes may be made of an electron-conductive substrate. The electron-conductive substrate passes through an active material solution through pores therein. Then, the active material solution may have an electrochemical reaction on the surface of carbon fiber, which forms the electron-conductive substrate. However, a comparable electron-conductive substrate made of carbon felt may not sufficiently provide enough of a reaction area that is required for a proper electrochemical reaction, thereby deteriorating efficiency of the battery.

According to an embodiment of the present invention, at least one of the positive electrode or the negative electrode includes an electron-conductive substrate and a fine carbon layer thereon, and thus has a larger reaction area than the comparable electron-conductive substrate. In addition, the electrode of the redox flow battery desirably has hydrophilic properties, rather than hydrophobic properties (water-repellent properties) to further improve its properties.

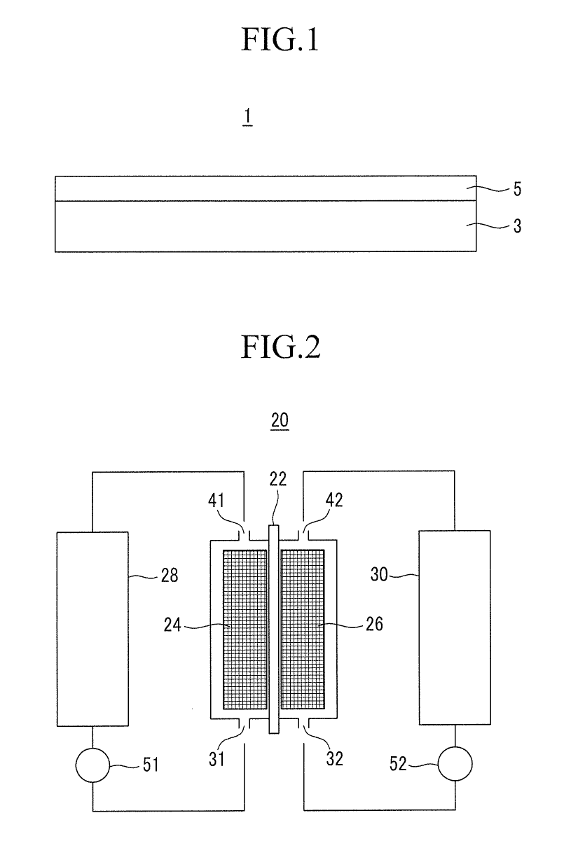

In other words, an electrode 1 (the at least one of the positive and negative electrodes), according to one embodiment of the present invention, includes an electron-conductive substrate 3 and a fine carbon layer 5 formed thereon as shown in FIG. 1.

The fine carbon layer 5 may include carbon black, carbon nanotube, or a mixture of carbon black and carbon nanotube. According to one embodiment of the present invention, the fine carbon layer 5 may include a mixture of carbon black and carbon nanotube. Herein, in one embodiment, the carbon black and the carbon nanotube are mixed in a ratio range from 90:10 wt % to 50:50 wt %. In one embodiment, when the carbon black and the carbon nanotube are mixed within the ratio range, they increase the surface area at which an electrochemical reaction occurs, and the fine carbon layer 5 includes suitably-distributed pores through which cations of an active material can transfer.

In one embodiment, the fine carbon layer 5 has a thickness in a range from 5 μm to 100 μm and in another embodiment, from 10 μm to 50 μm. In one embodiment, when the fine carbon layer 5 has a thickness within the range, it has a sufficiently large reaction surface area, but no resistance during transportation of cations of an active material, thereby improving voltage efficiency.

In one embodiment, the electron-conductive substrate 3 includes carbon paper, carbon cloth, carbon felt, or a combination thereof. In one embodiment, the electron-conductive substrate has a thickness in a range from 100 μm to 400 μm. In one embodiment, when an electron-conductive substrate has a thickness within the range, it has a sufficient surface area for a reaction, thereby no rate capability is deteriorated. In addition, since the electron-conductive substrate 3 includes a diffusion path in an appropriate level, it may bring about no rate capability deterioration due to extension of a diffusion path. Furthermore, it may maintain an appropriate volume and thus, maintain an appropriate power density and an appropriate energy density of the battery.

The electrode 1 may be fabricated by adding a carbon material selected from carbon black, carbon nanotube, or a mixture of carbon black and carbon nanotube to a solvent to prepare a fine carbon layer composition, and coating the fine carbon layer composition on an electron-conductive substrate. The solvent may include isopropyl alcohol, water, ethanol, propanol, or a combination thereof. In addition, the fine carbon layer composition may further include a binder. The binder may include polyperfluorosulfonic acid (Nafion), polyvinyl difluoride or polytetrafluoroethylene, and the like. In one embodiment, the carbon material and the solvent are mixed in a weight ratio in a range from 3:97 to 45:55. In one embodiment, the binder are mixed with the carbon material to have a weight ratio (weight of binder/weight of carbon material) in a range from 3/97 to 30/70. The binder may have a solid-phase. However, the binder may be used as a liquid, since a commercially-available binder is a liquid. When the binder is used as a liquid, the weight ratio of the binder and the carbon material indicates the weight ratio of a solid portion in the liquid and the carbon material.

According to an embodiment of the present invention, a redox flow battery includes a separator between the positive and negative electrodes, a positive electrode supplier including a positive active material liquid supplied to the positive electrode, and a negative electrode supplier including a negative active material liquid supplied to the negative electrode.

The separator may include a cation conductive polymer having a sulfonic acid group, a carboxylic acid group, a phosphoric acid group, a phosphonic acid group, or a cation exchange group of a derivative thereof at the side chain or include a porous polymer of porous polyethylene, porous polypropylene, porous polyvinylchloride, or a combination thereof. The cation conductive polymer may have the cation exchange group at the side chain and include, for example, at least one selected from a fluorine-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, or a polyphenylquinoxaline-based polymer.

The polymer forming the separator may include at least one selected from poly(perfluorosulfonic acid) (commercially available NAFION), poly(perfluorocarboxylic acid), a copolymer of tetrafluoroethylene having a sulfonic acid group, and fluorovinylether, polyarylene ether including sulfonic acid, sulfide polyetherketone, aryl ketone without or with the cation exchange group at the side chain, poly[(2,2′-m-phenylene)-5,5′-bibenzimidazole] without or with the cation exchange group at the side chain, or poly(2,5-benzimidazole) without or with the cation exchange group at the side chain.

In addition, the polymer may include a porous polymer such as porous polyethylene, porous polypropylene, porous polyvinylchloride, and the like.

The positive active material may be a +5-valent (pentavalent) to +4-valent (tetravalent) vanadium-based compound (e.g., a +5 oxidation state to +4 oxidation state vanadium-based compound). Examples of the positive active material may include (VO₂)₂SO₄, VO(SO₄), or a combination thereof.

The positive active material liquid may include a mixture of sulfuric acid and water as a solvent, that is, a sulfuric acid aqueous solution. In one embodiment, the mixture of sulfuric acid and water, that is, a sulfuric acid aqueous solution includes a sulfuric acid with a concentration in a range from 0.5 M to 4 M. In one embodiment, when the sulfuric acid aqueous solution has a concentration within the range, the sulfuric acid aqueous solution has appropriate proton conductivity and thus maintains output performance. In addition, the sulfuric acid aqueous solution may appropriately maintain viscosity while not decreasing the reaction speed of an active material.

In one embodiment, the positive active material liquid has a concentration in a range from 1 M to 10 M (of the positive active material in the liquid). In one embodiment, when the positive active material liquid has a concentration within the range, it can have high energy density and high power density. In one embodiment, when the positive active material liquid has a concentration of less than 1 M, it includes too little of the active material per unit volume, thereby decreasing energy density. On the other hand and in another embodiment, when the positive active material solution has a concentration of more than 10 M, it has sharply increased viscosity and thus, remarkably increased oxidation/reduction reaction speed, thereby deteriorating power density.

The negative active material may be a +2-valent (divalent) to +3-valent (trivalent) vanadium-based compound (e.g., a +2 oxidation state to +3 oxidation state vanadium-based compound) and include, for example, VSO₄, V₂(SO₄)₃, or a combination thereof.

The negative active material liquid may include a mixture of sulfuric acid and water, that is, a sulfuric acid aqueous solution as a solvent like the positive active material liquid.

In one embodiment, the negative active material liquid has a concentration in a range from 1 M to 10 M. In one embodiment, when the negative active material liquid has a concentration within the range, it brings about high energy density and high power density. In one embodiment, when the negative active material liquid has a concentration of less than 1 M, the active material per unit volume in the liquid is in too small of an amount, thereby deteriorating energy density of a battery. On the other hand and in another embodiment, when the negative active material solution has a concentration of more than 10 M, it has sharply increased viscosity and thus, remarkably decreased oxidation/reduction reaction speed, thereby deteriorating power density of a battery.

In addition, a redox flow battery according to an embodiment of the present invention further includes a polar plate on one side of the electron-conductive substrate, that is, on the one side facing oppositely away from the separator. The polar plate may be made of graphite. This polar plate may have a channel.

FIG. 2 schematically shows the structure of a redox flow battery. As shown in FIG. 2, a redox flow battery 20 may include an electrode assembly including a separator 22 with a positive electrode 24 and a negative electrode 26 positioned respectively on (at) both sides of the separator 22, a positive electrode tank 28 storing a positive active material supplied to the positive electrode 24, and a negative electrode tank 30 storing a negative active material supplied to the negative electrode 25. The positive active material stored in the positive electrode tank 28 is supplied through a pump 51, and then through a positive active material inlet 31 to the positive electrode 24. When a redox reaction is complete, the positive active material moves through a positive active material outlet 41 back to the positive electrode tank 28 again. Likewise, the negative active material stored in the negative electrode tank 30 is supplied through a pump 52 and then through a negative active material inlet 32 to the negative electrode 26. When a redox reaction is complete, the negative active material moves through a negative active material outlet 42 back to the negative electrode tank 30 again.

The following examples illustrate this disclosure in more detail. However, the following are exemplary embodiments and are not limiting.

### Example 1

1 g of carbon black was admixed to 20 g of isopropyl alcohol. Then, a 5 wt %

Nafion solution (a solvent: isopropylalcohol/water=1/1 volume ratio) was admixed to the resulting mixture in a weight ratio of Nafion and carbon black (a binder weight/a carbon black weight) of 0.33, thereby preparing a fine carbon layer composition.

The fine carbon layer composition was coated on one side of a 280 μ-thick carbon felt, thereby fabricating an electrode with a 30 μm-thick fine carbon layer thereon.

The electrodes were respectively positioned on both sides of a separator of a 180 μm-thick Nafion 117. Then, graphite polar plates were respectively positioned on the other sides of the positive and negative electrodes facing oppositely away from the separator, and then clamped, thereby fabricating a unit cell. Herein, the electrode area was 6 cm².

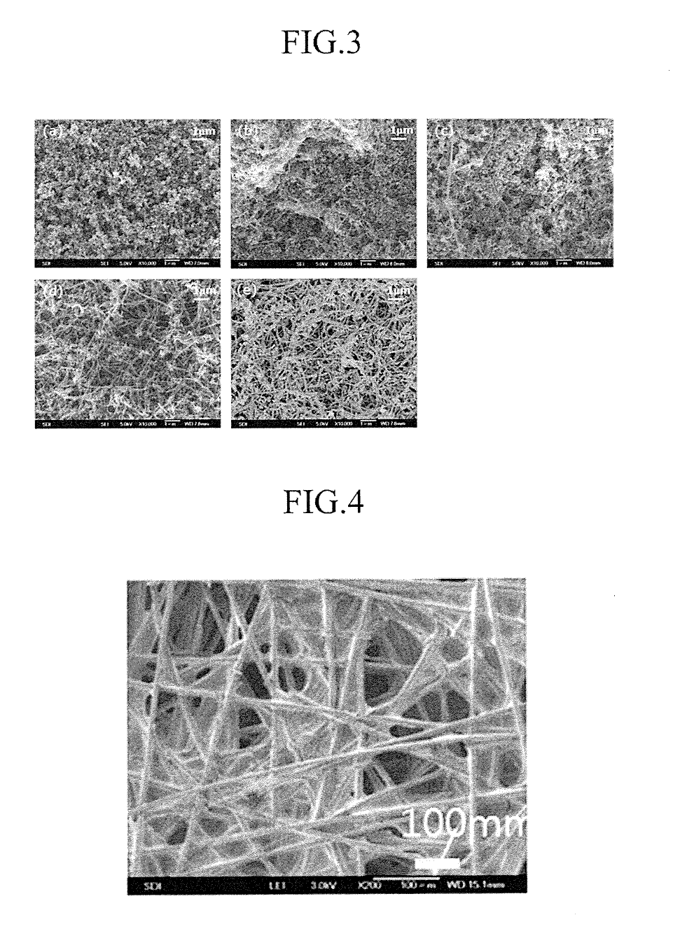

Next, 1.5 M of VO(SO₄) was dissolved in a sulfuric acid aqueous solution with a 3 M concentration (e.g., at a volume ratio of 1/1), thereby preparing a positive active material solution. In addition, 1.5 M of V₂(SO₄)₃ was dissolved in a sulfuric acid aqueous solution with a 3 M concentration (e.g., at a volume ratio of 1/1), thereby preparing a negative active material solution. The unit cell and the positive and negative active material solutions were used to fabricate a redox flow battery having a structure provided in FIG. 3.

### Example 2

Carbon black and carbon nanotube were mixed in a ratio of 83.3 wt % and 16.7 wt % in an isopropylalcohol solvent. Herein, the amount of carbon black and carbon nanotube was 1 g, while the isopropylalcohol solvent was 20 g. Then, a redox flow battery was fabricated according to the same method as Example 1 except for preparing a fine carbon layer composition by adding a 5 wt % Nafion solution (a solvent: isopropylalcohol/water=1/1) to the mixture to have 0.33 of a ratio between the Nafion weight and the carbon black and carbon nanotube weights.

### Example 3

Carbon black and carbon nanotube in a ratio of 67.7 wt % and 33.3 wt % were mixed in an isopropylalcohol solvent. Herein, the amount of carbon black and carbon nanotube were 1 g, while the isopropylalcohol solvent was 20 g. Then, a redox flow battery was fabricated according to the same method as Example 1 except for preparing a fine carbon layer composition by adding a 5 wt % Nafion solution (a solvent: isopropylalcohol/water=1/1) to the mixture to have 0.33 of a ratio between the Nafion weight and the carbon black and carbon nanotube weights.

### Example 4

Carbon black and carbon nanotube in a ratio of 50 wt % and 50 wt % were mixed in an isopropylalcohol solvent. Herein, the amount of carbon black and carbon nanotube was 1 g, while the amount of isopropylalcohol solvent was 20 g. Then, a redox flow battery was fabricated according to the same method as Example 1 except for using a fine carbon layer composition prepared by using a 5 wt % Nafion solution (a solvent: isopropylalcohol/water=1/1) added to the mixture to have 0.33 of a weight ratio between Nafion and carbon black.

### Example 5

A redox flow battery was fabricated according to the same method as Example 1 except for using a fine carbon layer composition prepared by adding 1 g of carbon nanotube to 20 g of an isopropylalcohol solvent and then, adding a 5 wt % Nafion solution (a solvent: isopropylalcohol/water=1/1) to the mixture to have 0.33 of weight ratio of Nafion and carbon nanotube.

### Comparative Example 1

A redox flow battery was fabricated according to the same method as Example 1 except for using a 280 μm-thick carbon felt as an electrode.

FIG. 3 shows SEM photographs of the electrodes according to Examples 1 to 5, wherein (a: Example 1), (b: Example 2), (c: Example 3), (d: Example 4) and (e: Example 5). FIG. 4 shows an SEM photograph of the electrode according to Comparative Example 1. Comparing FIG. 3 with FIG. 4, each of the electrodes having a fine carbon layer according to Examples 1 to 5 has a larger surface area and a better developed structure than the electrode having no fine carbon layer according to Comparative Example 1. Accordingly, the electrodes according to Examples 1 to 5 were expected to decrease diffusion resistance of an active material.

Then, the redox flow batteries according to Examples 1 to 5 and Comparative Example 1 were measured regarding voltage efficiency, coulombic efficiency, and energy efficiency by implanting 30 ml of the positive and negative active material solutions into the electrode assembly, and charging and discharging them with a current density of 50 mA/cm².

Herein, the voltage efficiency was calculated according to the following formula 1. The following average voltage indicates an average of voltage values varying somewhat depending on the time during the charge and discharge.

Voltage efficiency(%)=(average voltage during discharge/average voltage during charge)×100

Coulombic efficiency(%)=(discharge capacity/charge capacity)×100

Energy efficiency(%)=(voltage efficiency/100×coulombic efficiency/100)×100 Equation 1

These experiments were all performed at a room temperature. The results are provided in the following Table 1.

TABLE 1

| | Amount of carbon | Coulombic | Voltage | Energy |
|---|---|---|---|---|
| | nanotube | efficiency | efficiency | efficiency |
| | (wt %) | (%) | (%) | (%) |
| Comparative | — | 91.2 | 92.3 | 84.2 |
| Example 1 | | | | |
| Example 1 | 0.0 | 91.2 | 93.5 | 86.2 |
| Example 2 | 16.7 | 93.4 | 94.3 | 88.1 |
| Example 3 | 33.3 | 93.6 | 95.8 | 89.7 |
| Example 4 | 50.0 | 93.6 | 96.2 | 90.0 |
| Example 5 | 100.0 | 92.5 | 94.2 | 87.1 |

As shown in Table 1, each of the redox flow batteries further including a fine carbon layer according to Examples 1 to 5 had improved coulombic efficiency, voltage efficiency, and/or energy efficiency compared with the one having no fine carbon layer according to Comparative Example 1.

While this disclosure has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims. Therefore, the aforementioned exemplary embodiments should be understood to be exemplary in every way, but not limited thereto.

What is claimed is:

1. A redox flow battery comprising:
an electrode assembly comprising a separator with positive and negative electrodes respectively at both sides of the separator;
a positive electrode supplier comprising a positive active material liquid and configured to supply the positive active material liquid to the positive electrode; and
a negative electrode supplier comprising a negative active material liquid and configured to supply the negative active material liquid to the negative electrode,
wherein at least one of the positive electrode or the negative electrode comprises an electron-conductive substrate and a fine carbon layer formed thereon, and the fine carbon layer comprises carbon black, carbon nanotube, or a mixture of carbon black and carbon nanotube.

2. The redox flow battery of claim 1, wherein the fine carbon layer comprises the mixture of carbon black and carbon nanotube.

3. The redox flow battery of claim 2, wherein the mixture of carbon black and carbon nanotube comprises the carbon black and the carbon nanotube in a ratio range from 90:10 wt % to 50:50 wt %.

4. The redox flow battery of claim 1, wherein the fine carbon layer has a thickness in a range from 5 μm to 100 μm.

5. The redox flow battery of claim 1, wherein the fine carbon layer has a thickness in a range from 10 μm to 50 μm.

6. The redox flow battery of claim 1, wherein the electron-conductive substrate is carbon paper, carbon cloth, carbon felt, or a combination thereof.

7. The redox flow battery of claim 1, wherein the separator comprises a cation conductive polymer having a sulfonic acid group, a carboxylic acid group, a phosphoric acid group, a phosphonic acid group, or a cation exchange group of a derivative thereof at the side chain or comprises a porous polymer of porous polyethylene, porous polypropylene, porous polyvinylchloride, or a combination thereof.

8. The redox flow battery of claim 1, wherein the positive active material is a +5-valent to +4-valent vanadium-based compound.

9. The redox flow battery of claim 8, wherein the positive active material is (VO₂)₂SO₄, VO(SO₄), or a combination thereof.

10. The redox flow battery of claim 1, wherein the positive active material liquid comprises a mixture of sulfuric acid and water as a solvent.

11. The redox flow battery of claim 1, wherein the positive active material liquid has a concentration of the positive active material in a range from 1 M to 10 M.

12. The redox flow battery of claim 1, wherein the negative active material is a +2-valent to +3-valent vanadium-based compound.

13. The redox flow battery of claim 1, wherein the negative active material is VSO₄, V₂(SO₄)₃, or a combination thereof.

14. The redox flow battery of claim 1, wherein the negative active material liquid comprises a mixture of sulfuric acid and water as a solvent.

15. The redox flow battery of claim 1, wherein the negative active material liquid has a concentration of the negative active material in a range from 1 M to 10 M.

16. A redox flow battery comprising:
a separator;
an electrode on the separator; and
an electrode supplier comprising an active material liquid and configured to supply the active material liquid to the electrode,
wherein the electrode comprises an electron-conductive substrate and a fine carbon layer formed thereon, and the fine carbon layer comprises carbon black, carbon nanotube, or a mixture of carbon black and carbon nanotube.

17. The redox flow battery of claim 16, wherein the fine carbon layer comprises the mixture of carbon black and carbon nanotube.

18. The redox flow battery of claim 17, wherein the mixture of carbon black and carbon nanotube comprises the carbon black and the carbon nanotube in a ratio range from 90:10 wt % to 50:50 wt %.

19. The redox flow battery of claim 16, wherein the fine carbon layer has a thickness in a range from 5 μm to 100 μm.

20. The redox flow battery of claim 16, wherein the fine carbon layer has a thickness in a range from 10 μm to 50 μm.
